(19) United States
(12) Patent Application Publication
(10) Pub. No.: US 2008/0055098 A1
(43) Pub. Date: Mar. 6, 2008

(54) Ornament Based Detector With Remote Alarm

(76) Inventor: Marc Toland, Stamford, CT (US)

Correspondence Address: MORGAN LEWIS & BOCKIUS LLP, 1111 PENNSYLVANIA AVENUE NW, WASHINGTON, DC, 20004, US

(21) Appl. No.: 11/845,839

(22) Filed: Aug. 28, 2007

Related U.S. Application Data
(60) Provisional application No. 60/841,101, filed on Aug. 29, 2006.

(51) Int. Cl. G08B 17/10

(52) U.S. Cl. 340/628

(57) ABSTRACT

An ornament is provided including a detector, such as a carbon monoxide, smoke, temperature, and/or odor detector, a transmitter and optionally an alarm. Upon detection of smoke, heat, fire, carbon monoxide, etc., the transmitter sends a signal to a receiver in a remote alarm unit located apart from the ornament. The received signal causes an alarm in the remote alarm unit to activate.

### PRIORITY APPLICATION

This application claims the benefit of U.S. Provisional Patent Application No. 60/841,101 filed Aug. 29, 2006, titled Carbon Monoxide Smoke Detector With Remote Alarm Disguised As Christmas Ornament. The entire contents of that application are incorporated herein by reference.

### INTRODUCTION

The present invention is directed to a carbon monoxide, smoke detector or other sensing device disguised in an ornament, such as a holiday ornament, Christmas ornament, etc., that is used in combination with a remote alarm unit. Each year there are numerous residential and business fires caused by faulty holiday lights and ornaments. Such fires typically spread quickly and by the time a home fire alarm activates, a tree, plant, or other ornamental or decorative holder may be engulfed in flames, which may threaten the entire home. In the event that the activated fire alarm is located near the burning item, but far from occupants, the occupants may not hear the fire alarm.

Carbon monoxide is often detectable before flames are visible. It is therefore desirable to detect the presence of carbon monoxide as early as possible. There have been a number of patents directed to the field of heat and smoke sensors, e.g., U.S. Patent Application Nos. 20050212681 to Dzurko, 20050007255 to Morris, 20050007248 to Andres, 20040160329 to Flanc, 20010145465 to Stults, 20040056745 to Tseung, 20040032335 to Parrish, 20040021576 to Scott, 20030201908 to Becka, 20030179090 to Morris, 20020044061 to Johnston, U.S. Pat. No. 6,989,757 to Geoffrey, U.S. Pat. No. 6,975,223 to Mladen, U.S. Pat. No. 6,784,798 to Morris, U.S. Pat. No. 6,563,278 to Roman, U.S. Pat. No. 6,420,973 to Acevedo, U.S. Pat. No. 6,339,379 to Argus, U.S. Pat. No. 6,323,780 to Morris, U.S. Pat. No. 5,912,624 to Howard, U.S. Pat. No. 5,764,150 to Fleury, U.S. Pat. No. 6,930,586 to Tseung, U.S. Pat. No. 4,606,219 to Bout, and U.S. Design Pat. Nos. D308,646 to Grilk, D369,566 to Poon, D472,175 to Welsh, however, none of these provide the advantages and benefits of the inventions described herein.

### SUMMARY OF THE INVENTION

An ornament based detector with remote alarm is provided as described herein. In one embodiment, an alarm system is provided that includes an ornament; and a remote alarm unit. The ornament comprises a housing adapted to include a detector for carbon monoxide, a detector for smoke (or other detector), a first alarm and a transmitter for transmitting a signal to the remote alarm unit. The remote alarm unit comprises a receiver for receiving the signal from the transmitter, and a second alarm. Other features include, for example, activating the second alarm upon receipt of a signal from the transmitter, and maintaining the second alarm in an activated state when the signal from the transmitter ceases. A plurality of remote alarm units may be provided with the ornament.

In another embodiment, a combination detection and alarm system is provided including a detection unit concealed in an ornament, the detection unit comprising a detector, a first alarm, and a transmitter adapted to receive a signal from the detector and communicate the signal to a receiver of a remote alarm unit; wherein the remote alarm unit comprises the receiver and a second alarm adapted to be activated by a signal from the receiver. The detector may comprise a device capable of detecting at least one of the group of: carbon monoxide, smoke, temperature, or odor. The second alarm may be activated by a signal from the receiver when the receiver receives a signal from the transmitter and may be maintained in an activated state when the signal from the transmitter ceases.

In another embodiment, an alarm system is provided comprising an ornament; and a remote alarm unit. The ornament comprises a holiday light adapted to include a detector and a transmitter for transmitting a signal to the remote alarm unit. The remote alarm unit comprises a receiver for receiving the signal from the transmitter, and an alarm. The detector may comprise a device capable of detecting at least one of the group of: carbon monoxide, smoke, temperature, or odor. When the detector detects the at least one of the group, the detector may notify the transmitter and send a signal to the receiver that causes the alarm to activate. The alarm may maintain an activated state when the signal from the transmitter ceases. The alarm system may also be provided with a plurality of remote alarms units.

In another embodiment, a method for providing an alarm is described comprising: providing an ornament at a location near a fire hazard, wherein the ornament comprises a housing adapted to include a detector, a first alarm, and a transmitter for transmitting a signal to the remote alarm; and providing at least one remote alarm unit located apart from the ornament, wherein the at least one remote alarm units comprise a receiver for receiving the signal from the transmitter, and a second alarm. The detector comprises a device capable of detecting at least one of the group of: carbon monoxide, smoke, temperature, or odor.

### DESCRIPTION OF THE FIGURES

FIG. 1 is a perspective view of an ornament according to an embodiment of the invention;

FIG. 1a depicts an internal mechanism of an ornament according to an embodiment of the invention;

FIG. 2 depicts a housing for a remote alarm unit according to an embodiment of the invention;

FIG. 2a depicts an internal mechanism for a remote alarm unit according to an embodiment of the invention; and

FIG. 3 is a block diagram of an ornament and remote alarm unit according to an embodiment of the invention.

### DESCRIPTION OF EMBODIMENTS OF THE INVENTION

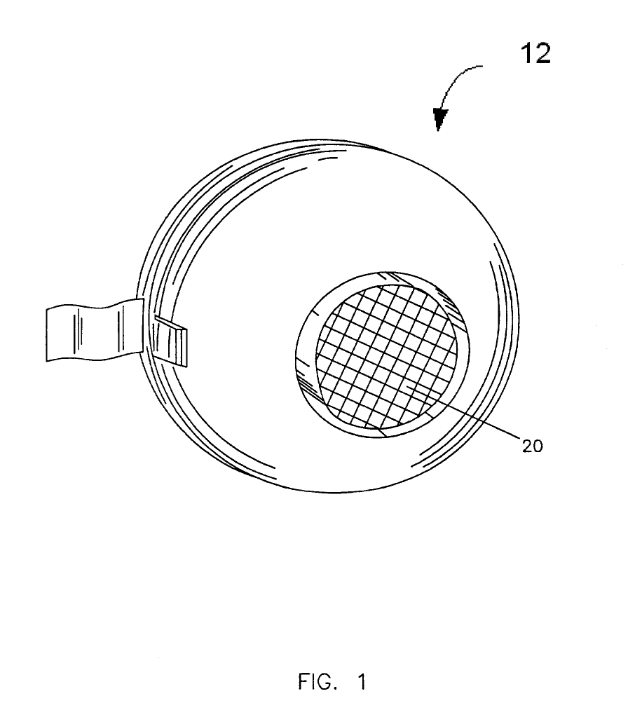

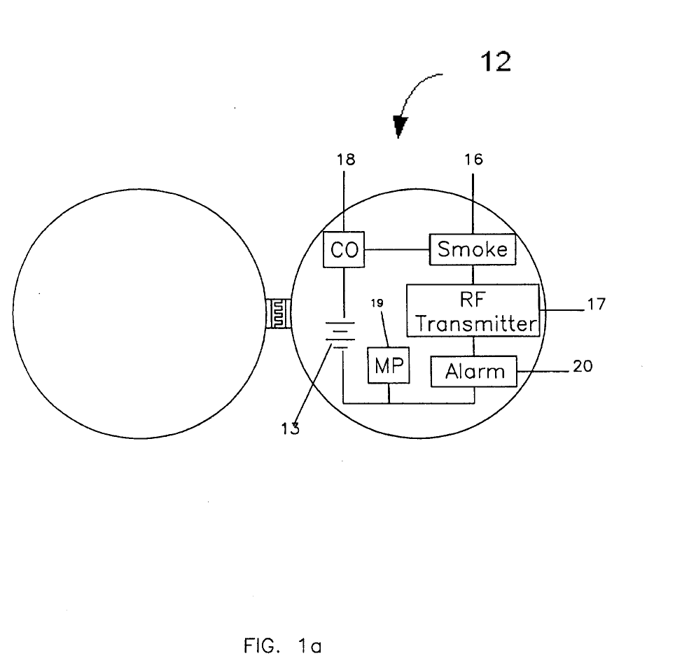

The present invention is described herein with reference to FIGS. 1-3. Referring to FIG. 1, an ornament 12 is depicted having a housing of a spherical shape similar to an ornament, such as a Christmas tree ball or other ornament. The shape and size of the ornament is not critical to the invention and one of skill in the art would recognize other suitable ornamental designs, shapes and sizes and applications (e.g., Christmas tree lights, other holiday lights, a kitchen decoration, a garage/utility room item, a barbeque-themed item, etc.) that may be appropriate for an alarm system described herein.

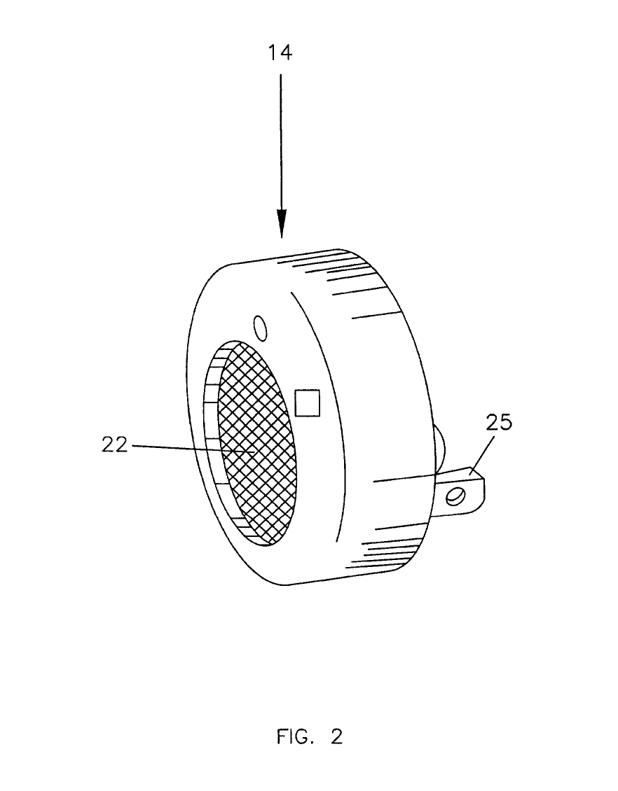

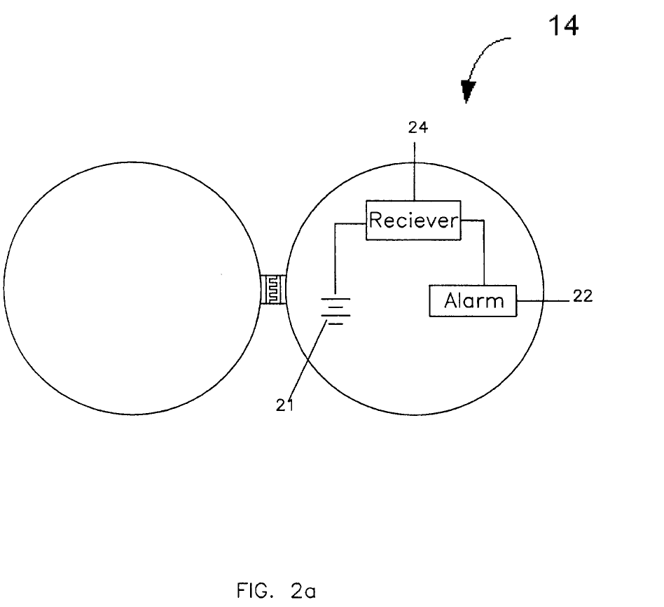

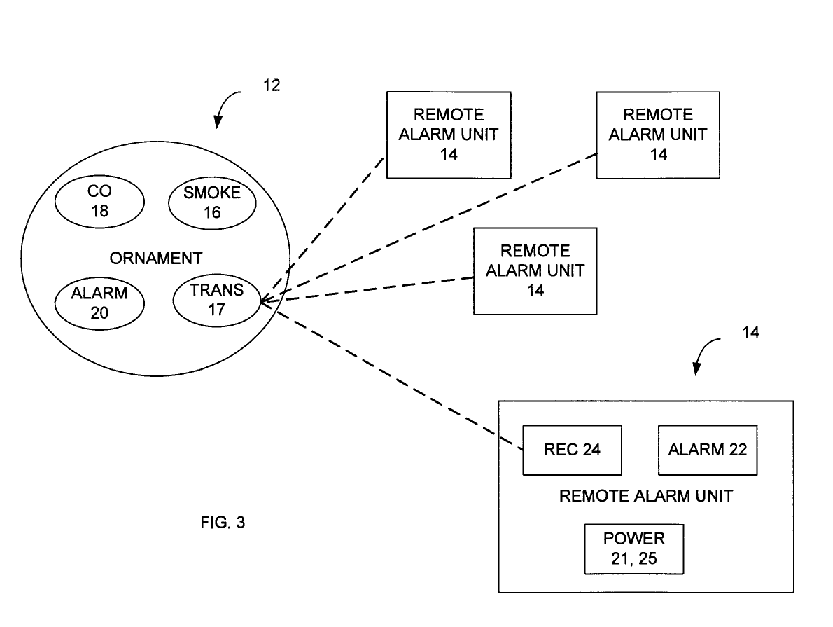

As shown in FIG. 1a, the ornament 12 typically has a power/battery source 13, smoke detector 16 and/or a carbon monoxide sensor 18, a transmitter 17, microprocessor 19 and an alarm 20. The smoke detector 16 and/or carbon monoxide sensor 18 may be a component known in the art suitable for an ornament or other small housing. Another type of detector (not shown) may also be provided in addition to or in place of the smoke detector 16 and/or carbon monoxide sensor 18. Examples of other detectors which may be provided include, for example, a heat or odor detector, etc. The transmitter 17 may be an RF transmitter or other communications component known in the art that is capable of transmitting a signal from the ornament 12 to a remote alarm unit 14 (FIGS. 2-3). The microprocessor 19 may be a processor chip capable of receiving a signal from one of the sensing components (16, 18), sending a signal to the transmitter for transmission to the remote alarm unit 14, and activating alarm 20. Alarm 20 may be any alarm having an audible, visible or other indicator.

Some embodiments of the ornament 12 may omit alarm 20 and include only a sensor/detector (e.g., 16, 18), transmitter 17 and microprocessor 19. In such embodiments, in the event that the sensor/detector detects smoke, heat, carbon monoxide, or other hazard, the microprocessor 19 directs the transmitter 17 to send a signal to the remote alarm unit(s) 14.

Turning now to FIGS. 2-3, a remote alarm unit 14 is provided having an alarm 22, power source 21, 25 and receiver 24. In general, the remote alarm unit 14 is provided and used separately from the ornament 12. In some exemplary uses, an ornament 12 may be placed near a potential hazard, e.g., on a Christmas tree in a living room, in a kitchen or garage, etc., and one or more remote alarm units 14 may be provided in bedrooms or other rooms.

The remote alarm unit 14 housing may be any small casing capable of containing the aforementioned components. The receiver 24 may be any receiving device capable of receiving a signal from the transmitter 17 of ornament 12. Upon receipt of a signal from the transmitter 17 of ornament 12, the receiver 24 will activate the alarm 22 (either directly or via a processor (not shown)). The alarm 22 may be any device capable of emitting an audible, visible or other indicator. In general, alarm 22 maintains an activated state and continues to emit the audible/visible indicator after the signal from the transmitter 17 has ceased. Thus, alarm 22 continues to function in the event that the ornament 12 and/or the ornament components are consumed or overcome by a fire.

The remote alarm unit 14 may be powered by batteries 21 or other power source or electrical outlet via adaptor 25. Since the remote alarm unit 14 may be battery operated or powered by an outlet, it can be easily moved from one location to another location. One or more remote alarm units 14 may be provided so that each can be placed in multiple locations to provide multiple alarms that can each be activated by signals received from the same ornament 12.

It will be appreciated that the present invention has been described by way of example only, and that improvements and modifications may be made to the invention without departing from the scope or spirit thereof.

I claim:

1. An alarm system comprising:
an ornament; and
a remote alarm unit;
wherein the ornament comprises a housing adapted to include a detector for carbon monoxide, a detector for smoke, a first alarm and a transmitter for transmitting a signal to the remote alarm unit; and
wherein the remote alarm unit comprises a receiver for receiving the signal from the transmitter, and a second alarm.

2. The alarm system of claim 1 wherein the second alarm is activated upon receipt of a signal from the transmitter.

3. The alarm system of claim 2 wherein the second alarm maintains an activated state when the signal from the transmitter ceases.

4. The alarm system of claim 1 further comprising a plurality of remote alarms units.

5. A combination detection and alarm system comprising:
a detection unit concealed in an ornament, the detection unit comprising a detector, a first alarm, and a transmitter adapted to receive a signal from the detector and communicate the signal to a receiver of a remote alarm unit; wherein the remote alarm unit comprises the receiver and a second alarm adapted to be activated by a signal from the receiver.

6. The system of claim 5 wherein the detector comprises a device capable of detecting at least one of the group of: carbon monoxide, smoke, temperature, or odor.

7. The system of claim 5 wherein the second alarm is activated by a signal from the receiver when the receiver receives a signal from the transmitter.

8. The system of claim 7 wherein the second alarm maintains an activated state when the signal from the transmitter ceases.

9. An alarm system comprising:
an ornament; and
a remote alarm unit;
wherein the ornament comprises a holiday light adapted to include a detector and a transmitter for transmitting a signal to the remote alarm unit; and
wherein the remote alarm unit comprises a receiver for receiving the signal from the transmitter, and an alarm.

10. The system of claim 9 wherein the detector comprises a device capable of detecting at least one of the group of: carbon monoxide, smoke, temperature, or odor.

11. The system of claim 10 wherein when the detector detects the at least one of the group, the detector notifies the transmitter.

12. The alarm system of claim 11 wherein the notified transmitter sends a signal to the receiver that causes the alarm to activate.

13. The alarm system of claim 10 wherein the alarm maintains an activated state when the signal from the transmitter ceases.

14. The alarm system of claim 9 further comprising a plurality of remote alarms units.

15. A method for providing an alarm, the method comprising:
providing an ornament at a location near a fire hazard, wherein the ornament comprises a housing adapted to include a detector, a first alarm, and a transmitter for transmitting a signal to the remote alarm; and
providing at least one remote alarm unit located apart from the ornament, wherein the at least one remote alarm units comprise a receiver for receiving the signal from the transmitter, and a second alarm.

16. The method of claim 15 wherein the detector comprises a device capable of detecting at least one of the group of: carbon monoxide, smoke, temperature, or odor.
